(19) United States
(12) Patent Application Publication
(10) Pub. No.: US 2019/0004524 A1
(43) Pub. Date: Jan. 3, 2019

(54) SYSTEM AND METHOD FOR PLANNING A VEHICLE PATH

(71) Applicant: Faraday&Future Inc., Gardena, CA (US)

(72) Inventors: Yizhou Wang, San Jose, CA (US); Changliu Liu, Albany, CA (US); Xiaoying Chen, Albany, CA (US); Chongyu Wang, San Jose, CA (US); Kai Ni, Sammamish, WA (US)

(21) Appl. No.: 15/691,617

(22) Filed: Aug. 30, 2017

Related U.S. Application Data
(60) Provisional application No. 62/382,175, filed on Aug. 31, 2016.

(51) Int. Cl. G05D 1/02; G01C 21/36; G01C 21/34

(52) U.S. Cl. CPC G05D 1/0214; G01C 21/3605; G06T 17/05; G05D 1/0231; G05D 2201/0213; G01C 21/3415

(57) ABSTRACT

A system and method for determining a path for autonomous navigation based on user input is described. The vehicle can include one or more sensors to collect data for generating a three-dimensional (3D) model of the vehicle's surroundings. A two-dimensional (2D) occupancy grid map can be generated from the 3D model and displayed at a computing device. In some examples, the occupancy grid map can be displayed at a user interface of the electronic device. The user interface can further accept user input in the form of one or more of a user-defined path, an endpoint, a vehicle pose, or a series of waypoints. Based on the user input, a finalized path for autonomous vehicle travel can be determined. Determining a finalized path can include determining an optimal, minimum-distance path, applying a smoothing algorithm, and/or applying a constraint to maintain a minimum distance from any static obstacles near the vehicle. While traveling along the finalized path, one or more sensors can monitor the vehicle's surroundings for obstacles. In response to a detected obstacle, the vehicle can stop and/or determine a new path for travel.

### CROSS-REFERENCE TO RELATED APPLICATIONS

This application claims the benefit of U.S. Provisional Application No. 62/382,175, filed Aug. 31, 2016, the entirety of which is hereby incorporated by reference.

### FIELD OF THE DISCLOSURE

This relates to a vehicle and, more particularly, to an autonomous vehicle configured to determine a path of motion based on user input via a user interface of a computing device.

### BACKGROUND OF THE DISCLOSURE

Fully or partially autonomous vehicles, such as autonomous consumer automobiles, offer convenience and comfort to passengers. In some examples, a fully or partially autonomous vehicle can maneuver into a parking space in certain conditions. For example, a vehicle can be a specified distance and/or orientation relative to a parking space prior to commencing a fully or partially autonomous parking operation. In some examples, a parking space for autonomous parking can be indicated with a visual or location-based marker.

### SUMMARY OF THE DISCLOSURE

The present disclosure relates to a vehicle and, more particularly, to an autonomous vehicle configured to determine a path of motion based on user input at via user interface of a computing device. In some examples, the vehicle can load or generate a three-dimensional (3D) model of its surroundings to be used in a fully or partially autonomous parking operation. For instance, a two-dimensional (2D) “occupancy grid map” can be generated from the 3D model to determine unobstructed sections of road the vehicle can proceed. The 2D occupancy grid map can be displayed at a computing device, such as a mobile device (e.g., a smartphone, a tablet, or other mobile device) or a device included in the vehicle (e.g., an infotainment panel or other in-vehicle device). In some examples, the user can provide input to instruct the vehicle where to travel to. The user input can include one or more of a path, a final location, a final pose (location and orientation), or a series of waypoints, for example. In some examples, the vehicle can generate a path based on the user input and optimize and smooth the generated path to plan its path. The vehicle can drive in a fully or partially autonomous mode along the finalized path. In some examples, the path can lead to a parking location and the vehicle can autonomously park at the end of the path.

### BRIEF DESCRIPTION OF THE DRAWINGS

FIG. 1 illustrates an exemplary system block diagram of vehicle control system according to examples of the disclosure.

FIG. 2A illustrates a 3D model of an exemplary parking garage according to examples of the disclosure.

FIG. 2B illustrates an exemplary 2D occupancy grid map according to examples of the disclosure.

FIGS. 3A-3B illustrate exemplary user interfaces for inputting a vehicle path according to examples of the disclosure.

FIGS. 4A-4B illustrate exemplary user interfaces for inputting a vehicle endpoint according to examples of the disclosure.

FIGS. 5A-5B illustrate exemplary user interfaces for inputting a vehicle pose according to examples of the disclosure.

FIGS. 6A-6B illustrate exemplary user interfaces for inputting a series of vehicle waypoints according to examples of the disclosure.

FIG. 7 illustrates an exemplary process for planning a vehicle path of travel based on user input according to examples of the disclosure.

FIG. 8 illustrates an exemplary process for avoiding a collision while autonomously driving along a pre-determined path according to examples of the disclosure.

### DETAILED DESCRIPTION

In the following description, reference is made to the accompanying drawings which form a part hereof, and in which it is shown by way of illustration specific examples that can be practiced. It is to be understood that other examples can be used and structural changes can be made without departing from the scope of the examples of the disclosure.

The present disclosure relates to a vehicle and, more particularly, to an autonomous vehicle configured to determine a path of motion based on user input at via user interface of a computing device. In some examples, the vehicle can load or generate a three-dimensional (3D) model of its surroundings to be used in a fully or partially autonomous parking operation. For instance, a two-dimensional (2D) “occupancy grid map” can be generated from the 3D model to determine unobstructed sections of road the vehicle can proceed. The 2D occupancy grid map can be displayed at a computing device, such as a mobile device (e.g., a smartphone, a tablet, or other mobile device) or a device included in the vehicle (e.g., an infotainment panel or other in-vehicle device). In some examples, the user can provide input to instruct the vehicle where to travel to. The user input can include one or more of a path, a final location, a final pose (location and orientation), or a series of waypoints, for example. In some examples, the vehicle can generate a path based on the user input and optimize and smooth the generated path to plan its path. The vehicle can drive in a fully or partially autonomous mode along the finalized path. In some examples, the path can lead to a parking location and the vehicle can autonomously park at the end of the path.

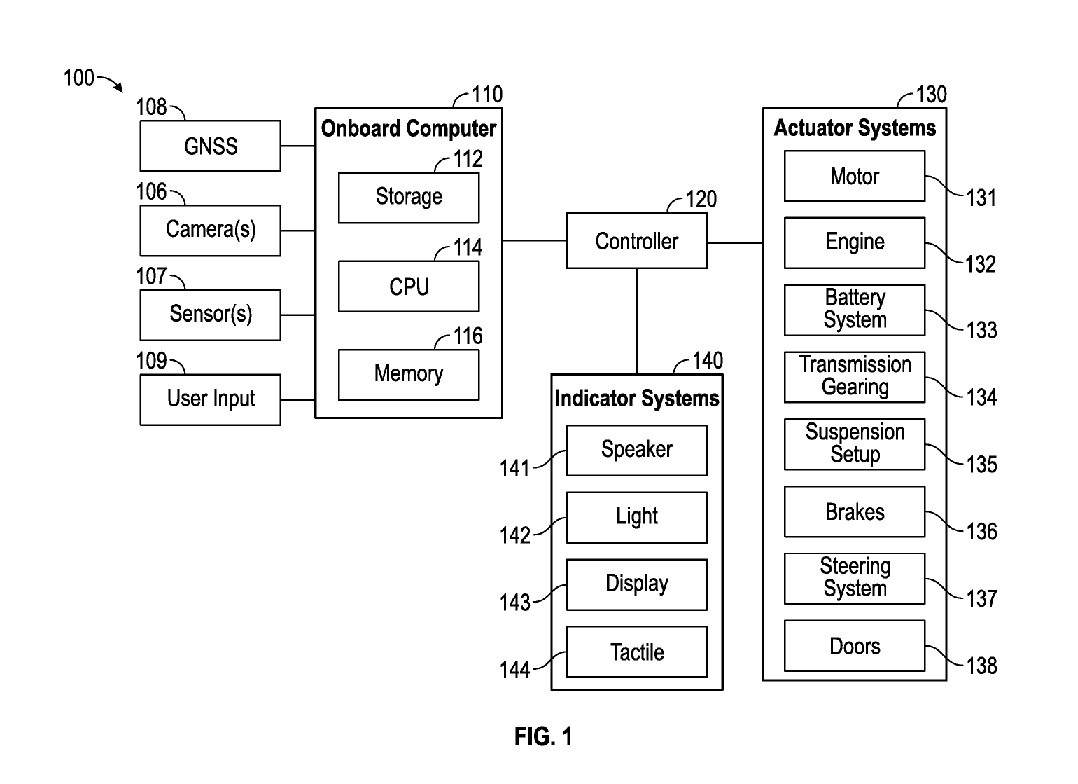

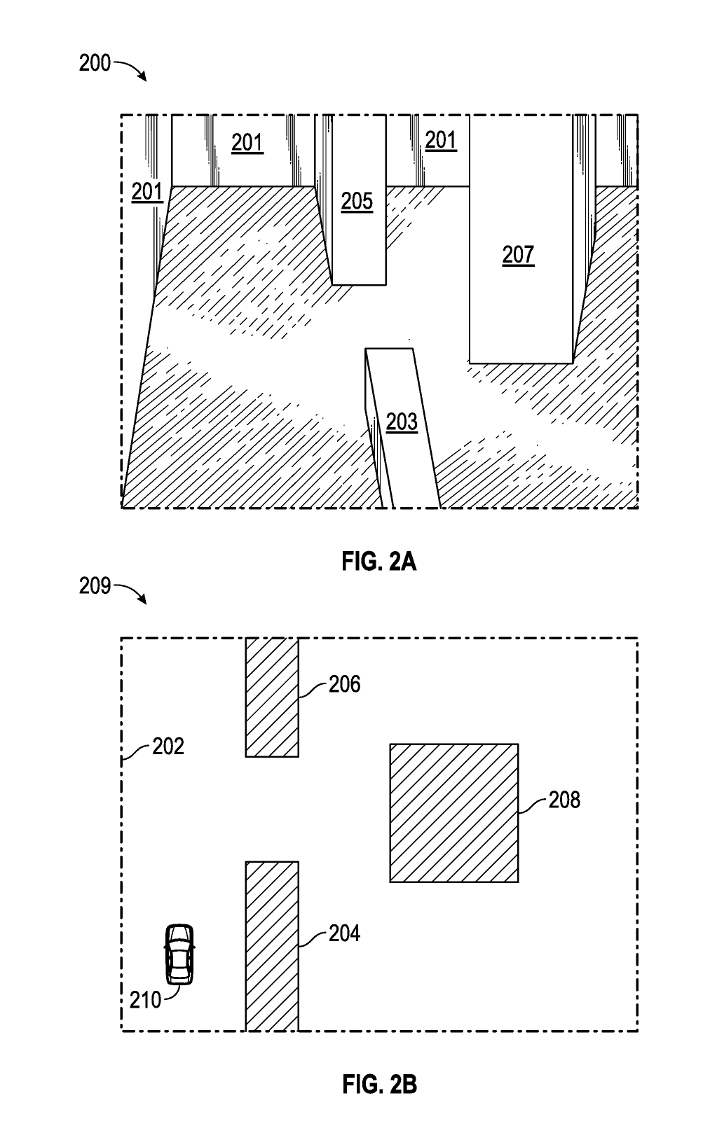

FIG. 1 illustrates an exemplary system block diagram of vehicle control system 100 according to examples of the disclosure. Vehicle control system 100 can perform any of the methods as will be described below with reference to FIGS. 2-8. System 100 can be incorporated into a vehicle, such as a consumer automobile. Other example vehicles that may incorporate the system 100 include, without limitation, airplanes, boats, or industrial automobiles. In some examples, vehicle control system 100 can be operatively coupled to a computing device (not shown), such as a mobile device or an in-vehicle device configured to receive one or more user inputs, as will be described below. Vehicle control system 100 can include one or more cameras 106 capable of capturing image data (e.g., video data) for determining various features of the vehicle's surroundings. Vehicle control system 100 can also include one or more other sensors 107 (e.g., radar, ultrasonic, LIDAR, etc.) capable of detecting various features of the vehicle's surroundings, and a Global Navigation Satellite System (GNSS) receiver 108 (e.g., a Global Positioning System (GPS) receiver, a BeiDou receiver, a GLONASS receiver, a Galileo receiver, etc.) capable of determining the location of the vehicle. Vehicle control system 100 can further include one or more user input devices 109, such as buttons, switches, pedals, touch screens, bioinformatics sensors (e.g., fingerprint sensors, electroencephalograms, etc.), or voice control devices, for examples. In some examples, the one or more sensors 107 can be used to generate a 3D model of the vehicles surroundings and/or detect an obstacle in the way of a pre-determined path for the vehicle to autonomously drive along. In some examples, one or more user input devices 109 can be used to allow a user to provide information about a desired path or alert the vehicle of an obstacle while driving in an autonomous driving mode.

Vehicle control system 100 can include an on-board computer 110 that is coupled to the cameras 106, sensors 107, GNSS receiver 108 and user input devices 109, and that is capable of receiving, for example, image data from the cameras and/or outputs from the sensors 107, the GNSS receiver 108, and user input devices 109. The on-board computer 110 can be capable of generating a 3D model of the vehicle's surroundings, generating a 2D occupancy grid map, and performing one or more optimization and/or smoothing algorithms on a pre-determined vehicle path, as described in this disclosure. On-board computer 910 can include storage 112, memory 116, and a processor 114. Processor 114 can perform any of the methods as will be described below with reference to FIGS. 2-8. Additionally, storage 112 and/or memory 116 can store data and instructions for performing any of the methods as will be described with reference to FIGS. 2-8. Storage 112 and/or memory 116 can be any non-transitory computer readable storage medium, such as a solid-state drive or a hard disk drive, among other possibilities. The vehicle control system 100 can also include a controller 120 capable of controlling one or more aspects of vehicle operation, such as performing autonomous driving operations.

In some examples, the vehicle control system 100 can be connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137 and door system 138. The vehicle control system 100 can control, via controller 120, one or more of these actuator systems 130 during vehicle operation; for example, to control the vehicle during autonomous driving operations, which can utilize the feature map and driving route stored on the on-board computer 110, using the motor 131 or engine 132, battery system 133, transmission gearing 134, suspension setup 135, brakes 136 and/or steering system 137, etc. Actuator systems 130 can also include sensors that send dead reckoning information (e.g., steering information, speed information, etc.) to on-board computer 110 (e.g., via controller 120) to determine the vehicle's location and orientation. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). The vehicle control system 100 can control, via controller 120, one or more of these indicator systems 140 to provide visual and/or audio indications that the vehicle detected a cautionary scenario.

FIG. 2A illustrates a 3D model 200 of an exemplary parking garage according to examples of the disclosure. For example, the model 200 of the exemplary parking garage can include static objects, such as exterior walls 201, divider 203, interior wall 205, and pillar 207. One or more sensors (e.g., LIDAR, ultrasonic, cameras, etc.) included in a vehicle can detect one or more static objects surrounding the vehicle, for example. In some examples, the vehicle can build the model 200 of the parking garage in real-time as it moves though the parking garage, making more sections of the garage visible. Building a model in real-time can allow a vehicle to autonomously park in a location for which a model is not already available. In some examples, a parking garage model can be stored in a memory (e.g., memory 116) included in the vehicle or downloaded from a second vehicle or from a remote server. Providing a pre-stored or downloaded model can allow the vehicle to plan a route to a location not presently “visible” to its sensors, for example. In some examples, a 3D model generated in real-time can be stored (e.g., in a memory included in the vehicle) or uploaded (e.g., to a remote server or to another vehicle) to be used again at a later time. The vehicle can use the 3D model to determine a 2D occupancy grid map including the footprints of the detected static objects.

FIG. 2B illustrates an exemplary 2D occupancy grid map 209 according to examples of the disclosure. In some examples, the vehicle can generate the occupancy grid map 209 from the 3D model 200. For example, divider 204 can be a footprint of divider 104. Accordingly, divider 204 can be an obstructed area of occupancy grid map 200, even though its height can be shorter than the height of other features such as interior wall 106 and pillar 108. The occupancy grid map 209 can illustrate obstructed and unobstructed areas near the vehicle to show where the vehicle can drive without a collision. For example, occupancy grid map 209 can include exterior walls 202, divider 204, interior wall 206, and pillar 208, each representing a footprint of their corresponding features included in the 3D model 200. In some examples, occupancy grid map 200 can further include the vehicle 210 itself to illustrate the vehicle's position relative to the other features of the model. In some examples, the occupancy grid map 209 can be stored at a memory included in the vehicle or uploaded to another vehicle or a remote server to be used at another time. The occupancy grid map 200 can be displayed at a user interface of a computing device (e.g., a mobile device such as a smartphone or tablet or an in-vehicle device such as an infotainment panel) to allow a user to provide input instructing the vehicle where to drive.

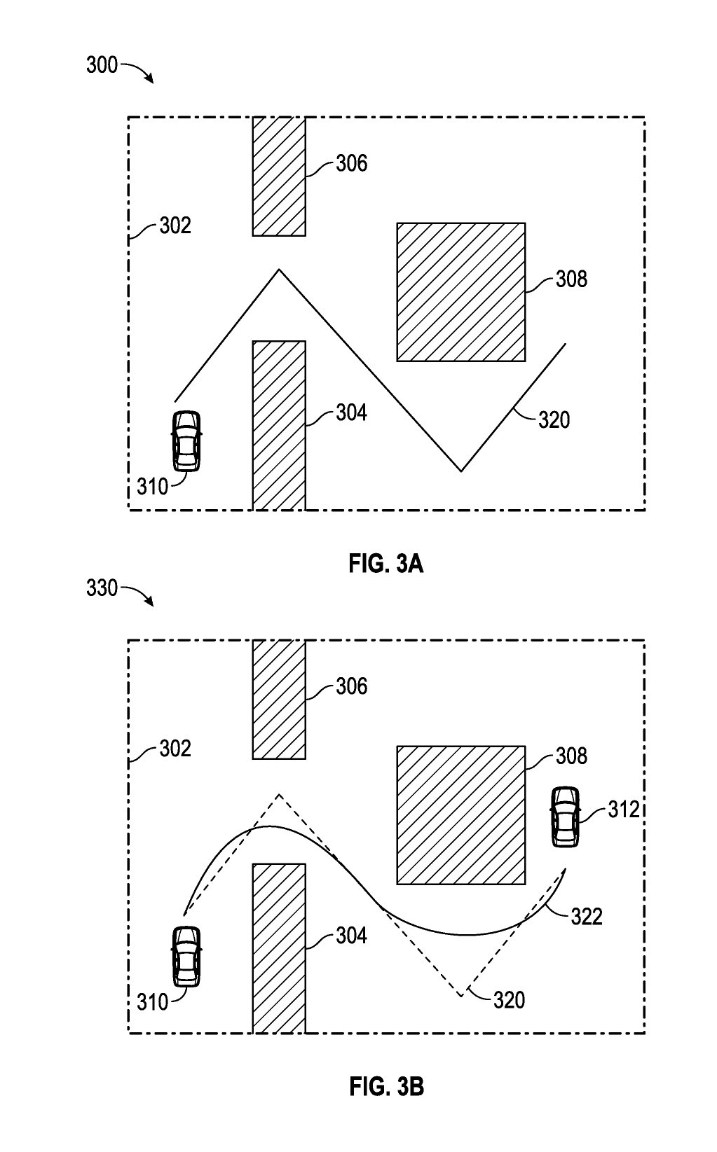

FIGS. 3A-3B illustrate exemplary user interfaces 300 and 330 for inputting a vehicle path 320 according to examples of the disclosure. User interfaces 300 and 330 can include exterior walls 302, divider 304, interior wall 306, pillar 308, and vehicle 310, which can correspond to features of the occupancy grid map 209, for example. FIG. 3A illustrates user interface 300 for accepting a vehicle path 320 input by a user, for example. In some examples, the vehicle path 320 can instruct the vehicle how to autonomously travel to a parking space. User interface 300 can be displayed on a touch screen, allowing the user to input the path by “drawing” it with their finger, a stylus, or another input device, for example. In some examples, other input modalities, such as a mouse or a keypad are possible.

In response to the user-provided path, an onboard computer of the vehicle can smooth and optimize the path to prepare the vehicle to autonomously travel in the direction indicated. FIG. 3B illustrates a user interface 330 including a finalized vehicle path 322, for example. User interface 330 can further include an indication 312 of a parking location of the vehicle, for example. In some examples, a path 320 input by a user may not be optimal for vehicle travel. For example, path 320 can include sharp turns, inefficiencies, or come too close to an obstacle. An onboard computer of the vehicle can apply a smoothing algorithm to eliminate sharp turns, for example. In some examples, a smoothing algorithm can capture an overall shape of an inputted path while eliminating some finer shapes of the path to make its overall shape smoother. In some examples, the onboard computer can further apply an optimization algorithm to reduce the total distance to be traveled between the vehicle's current location and the end of path 320. Additionally, in some examples, the onboard computer can apply a constraint to maintain a predetermined distance between the vehicle and any detected obstacles in the vehicle's vicinity. The finalized path 322 can be displayed as the vehicle autonomously drives to its parking location.

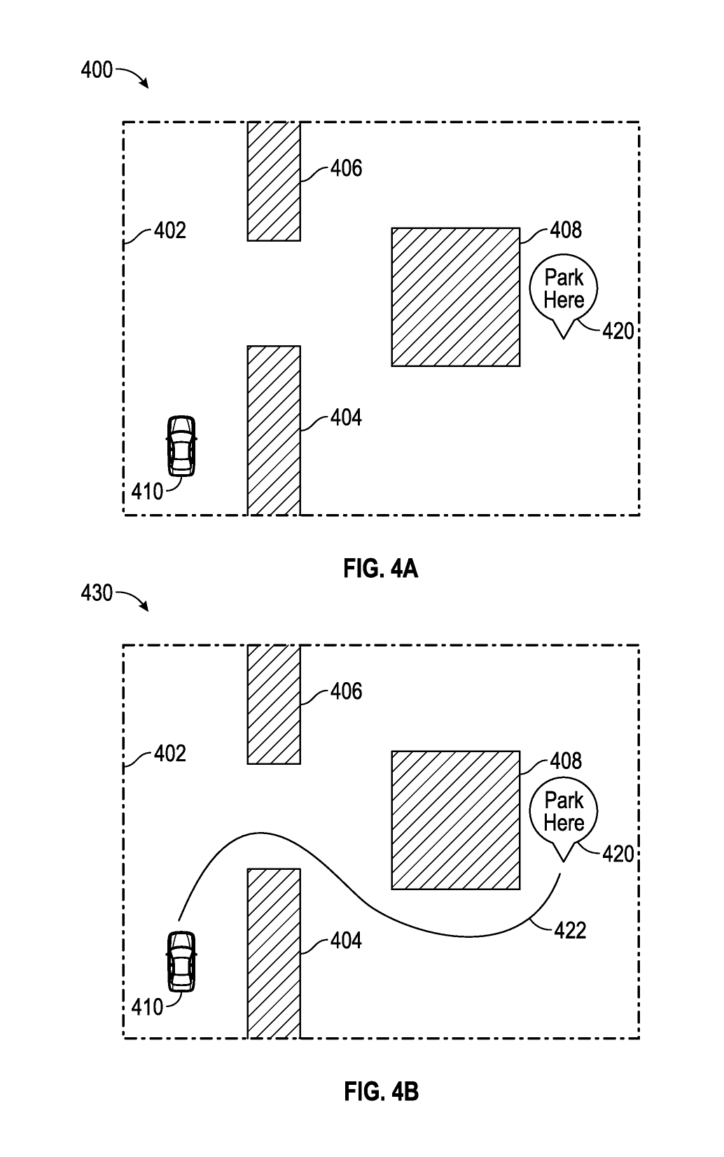

FIGS. 4A-4B illustrate exemplary user interfaces 400 and 430 for inputting a vehicle endpoint 420 according to examples of the disclosure. User interfaces 400 and 430 can include exterior walls 402, divider 404, interior wall 406, pillar 408, and vehicle 410, which can correspond to features of the occupancy grid map 209, for example. FIG. 4A illustrates user interface 400 for accepting a vehicle endpoint 420 input by a user, for example. In some examples, the vehicle endpoint 420 can instruct the vehicle where to autonomously park. User interface 400 can be displayed on a touch screen, allowing the user to input the endpoint using their finger, a stylus, or another input device, for example. In some examples, other input modalities, such as a mouse or a keypad are possible.

In response to the user-provided endpoint, an onboard computer of the vehicle can plan a path from the vehicle's current location to the endpoint. FIG. 4B illustrates a user interface 430 including a vehicle path 422, for example. In some examples, vehicle path 422 can be determined by an onboard computer included in the vehicle. The path 422 can be based on a searching algorithm to determine an optimal path to the user-defined endpoint 420. Although the optimal path can be the minimum path between the vehicle 410 and endpoint 420, the optimal path may be impractical for use. For example, the optimal path can include sharp turns and/or come too close to one or more obstacles near the vehicle. The onboard computer of the vehicle can apply a smoothing algorithm to eliminate any sharp turns included in the optimal path, for example. Additionally, in some examples, the onboard computer can apply a constraint to path 422 to maintain a predetermined distance between the vehicle and any detected obstacles in the vehicle's vicinity. The finalized path 422 can be displayed while the vehicle autonomously drives to the user-provided endpoint 420.

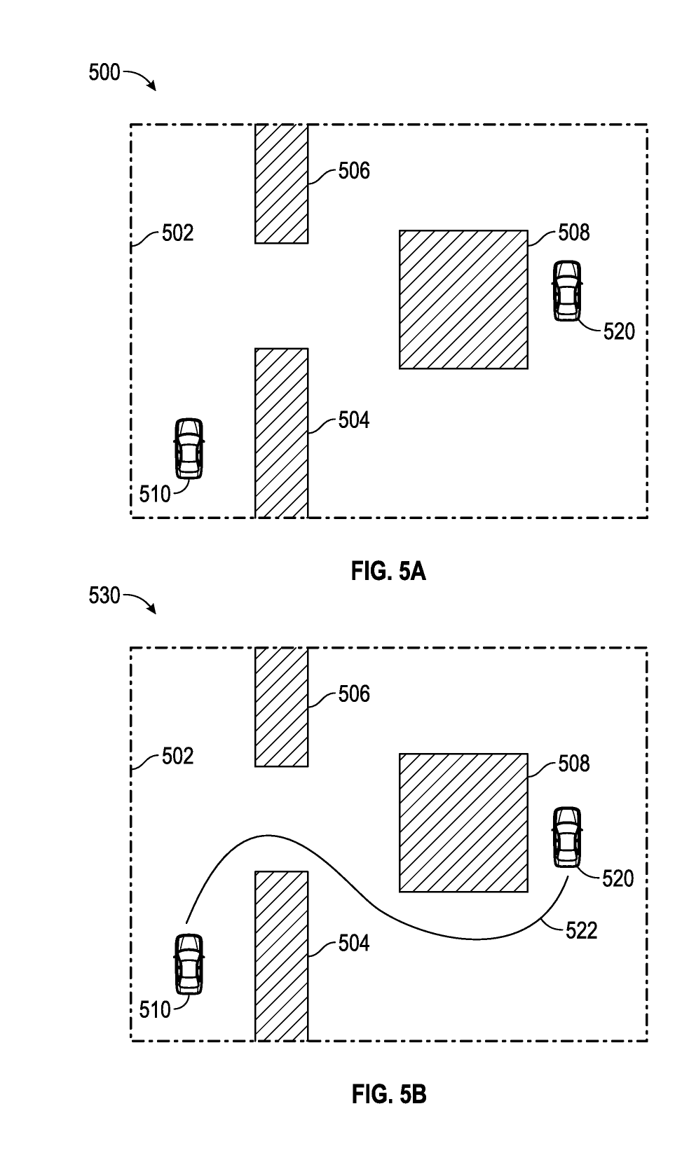

FIGS. 5A-5B illustrate exemplary user interfaces 500 and 530 for inputting a vehicle pose 520 according to examples of the disclosure. In some examples, vehicle pose 520 includes a location and a heading of the vehicle. User interfaces 500 and 530 can include exterior walls 502, divider 504, interior wall 506, pillar 508, and vehicle 510, which can correspond to features of the occupancy grid map 200, for example. FIG. 5A illustrates user interface 500 for accepting a vehicle pose 520 input by a user, for example. In some examples, the vehicle pose 520 can provide the vehicle with a location and heading in which to autonomously park. User interface 500 can be displayed on a touch screen, allowing the user to input the pose 520 using their finger, a stylus, or another input device, for example. In some examples, other input modalities, such as a mouse or a keypad are possible.

In response to the user-provided endpoint, an onboard computer of the vehicle can plan a path from the vehicle's current location to the provided pose 520. FIG. 5B illustrates a user interface 530 including a finalized vehicle path 522, for example. In some examples, the finalized path 522 can be determined by an onboard computer included in the vehicle. The path 522 can be determined based on a searching algorithm to determine an optimal path to the user-defined pose 520. Although the optimal path can be the minimum path of travel between the vehicle 510 and pose 520, the optimal path may be impractical for use. For example, the optimal path can include sharp turns and/or come too close to one or more obstacles near the vehicle. The onboard computer of the vehicle can apply a smoothing algorithm to eliminate any sharp turns included in the optimal path, for example. Additionally, in some examples, the onboard computer can apply a constraint to maintain a predetermined distance between the vehicle and any detected obstacles in the vehicle's vicinity. The finalized path 522 can be displayed as the vehicle autonomously drives to the user-provided vehicle pose 520.

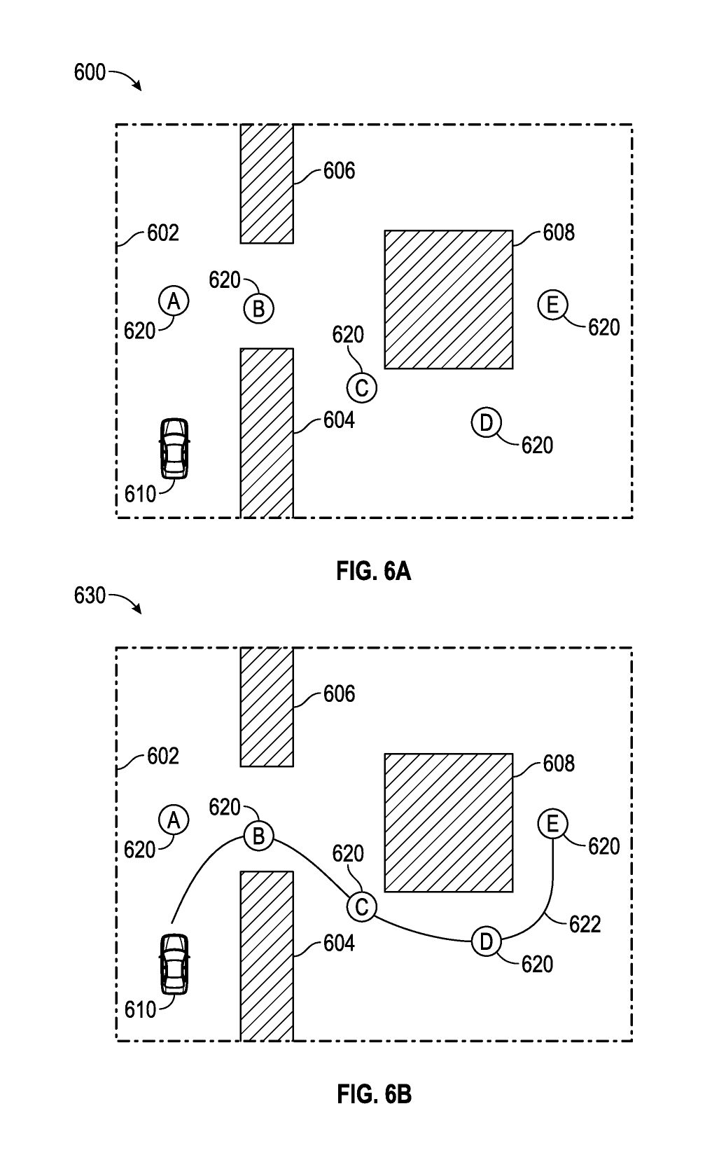

FIGS. 6A-6B illustrate exemplary user interfaces 600 or 630 for inputting a series of vehicle waypoints 620 according to examples of the disclosure. User interfaces 600 and 630 can include exterior walls 602, divider 604, interior wall 606, pillar 608, and vehicle 610, which can correspond to features of the occupancy grid map 200, for example. FIG. 6A illustrates user interface 600 for accepting a series of vehicle waypoints 620 input by a user, for example. In some examples, the vehicle waypoints 620 can provide a series of locations for the vehicle to travel through to arrive at a parking spot. User interface 600 can be displayed on a touch screen, allowing the user to input the vehicle waypoints 620 using their finger, a stylus, or another input device, for example. In some examples, other input modalities, such as a mouse or a keypad are possible.

In response to the user-provided vehicle waypoints, an onboard computer of the vehicle can plan a path from the vehicle's current location along the waypoints 620. FIG. 6B illustrates a user interface 630 including a finalized vehicle path 622, for example. The finalized path 622 can be determined by an onboard computer included in the vehicle by connecting the waypoints 620 to estimate a path, and then optimizing and smoothing the estimated path, for example. In some examples, the estimated path formed by joining waypoints 620 can include sharp turns, inefficiencies, and/or come too close to one or more obstacles near the vehicle. An optimizing algorithm can be applied to the estimated path so that finalized path 622 can be more efficient, for example. In some examples, not all waypoints 620 are included in the finalized vehicle path 622. For example, as shown in FIG. 6B, waypoint “A” is not included in path 622. The onboard computer of the vehicle can further apply a smoothing algorithm to eliminate any sharp turns included in the optimal path, for example. Additionally, in some examples, the onboard computer can apply a constraint to maintain a predetermined distance between the vehicle and any detected obstacles in the vehicle's vicinity. The finalized path 622 can be displayed while the vehicle autonomously drives in the general direction defined by the waypoints 620.

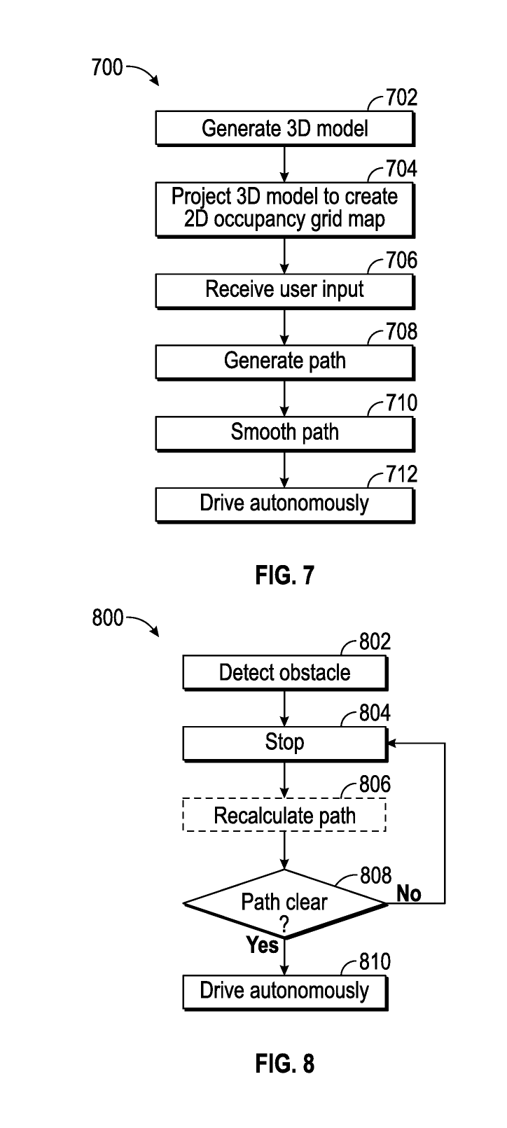

FIG. 7 illustrates an exemplary process 700 for planning a vehicle path of travel based on user input according to examples of the disclosure. In some examples, process 700 can be based on user input described with reference to FIGS. 3-6. Process 700 can be performed using one or more processors included in a vehicle.

In some examples, the vehicle can generate 702 a 3D model (e.g., model 200) of its surroundings. Generating a 3D model can include collecting perception data at one or more vehicle sensors (e.g., LIDAR, ultrasonic, cameras, etc.) included in the vehicle. In some examples, the 3D model can be built in real-time as the vehicle navigates its surroundings. Additionally or alternatively, a partial or complete 3D model can be obtained from previously-collected data. For example, a memory included in the vehicle can include pre-stored data or a partial or complete 3D model. Pre-stored data or a pre-stored model can be previously obtained by the vehicle itself and saved or it can be downloaded from a second vehicle or from a remote server.

In some examples, the vehicle can use the 3D model to generate 704 a 2D occupancy grid map, such as one or more of the occupancy grid maps described with reference to FIGS. 2-6. The occupancy grid map can include a footprint of the obstacles detected in the 3D model of the vehicle's surroundings. In some examples, the occupancy grid map can be built in real-time as the vehicle navigates its surroundings and collects 3D data. Additionally or alternatively, a partial or complete occupancy grid map can be obtained from previously-collected data. For example, a memory included in the vehicle can include pre-stored data or a partial or complete occupancy grid map. Pre-stored data or a pre-stored model can be previously obtained by the vehicle itself and saved or it can be downloaded from a second vehicle or from a remote server.

In some examples, the vehicle can receive 706 a user input to create a path for the vehicle to travel along. The user input can include one or more of a path (e.g., path 320), an endpoint (e.g., endpoint 420), a vehicle pose (e.g., vehicle pose 520), or a series of waypoints (e.g., waypoints 620), for example. In some examples, the user input can be provided at a user interface of a computing device, such as a mobile device (e.g., a smartphone, a tablet, etc.) or an in-vehicle device (e.g., an infotainment panel or other in-vehicle device). The device can include a touch screen to allow for touch input using the user's finger, a stylus, or other object, for example. In some examples, other input devices, such as a keyboard or a mouse, are possible.

In some examples, the vehicle can generate 708 a path from its current location to a second location, such as a parking spot. In some examples, a path can be provided by user input in the form of a user-provided path (e.g., path 320) or a series of waypoints (e.g., waypoints 620). Additionally or alternatively, an onboard computer included in the vehicle can use a searching algorithm to determine a minimum path to a user-provided endpoint (e.g., endpoint 420) or vehicle pose (e.g., vehicle pose 520). In some examples, the path can be displayed at a user interface including an occupancy grid map of the vehicle's surroundings.

In some examples, the vehicle can smooth 710 the generated 708 path. The onboard computer of the vehicle can perform a smoothing algorithm to eliminate sharp turns from the path. In some examples, smoothing can further include applying a constraint to the path to require a predetermined distance between the vehicle and its surroundings to avoid a collision. In some examples, the finalized path can be displayed at a user interface including an occupancy grid map of the vehicle's surroundings.

In some examples, the vehicle can autonomously drive 712 along the path. Autonomously driving along the path can include, in some examples, performing an autonomous parking operation at the end of the path. The vehicle can rely on one or more sensors (e.g., cameras, LIDAR, ultrasonic, etc.) to avoid a collision while driving autonomously. Avoiding a collision while driving autonomously along a path is described in more detail below with reference to FIG. 8. In some examples, partially autonomous driving modes are possible.

FIG. 8 illustrates an exemplary process 800 for avoiding a collision while autonomously driving along a pre-determined path according to examples of the disclosure. In some examples, process 800 can be performed in conjunction with one or more examples described above with reference to FIGS. 1-7.

In some examples, while driving along a pre-determined path, a vehicle can detect 802 an obstacle. The vehicle can detect the obstacle with one or more sensors such as LIDAR, cameras, or ultrasonic sensors, for example. Other sensors are possible. In some examples, a user can provide an input (e.g., via voice command, via a button or switch, via an electroencephalogram or other bioinformatics sensor, or by pressing the brake pedal, for example) that an obstacle is detected. In some examples, detecting 802 an obstacle can include detecting an object located along or in close proximity to the vehicle's pre-determined route. Additionally or alternatively, the vehicle can detect obstacles that do not yet overlap the route but, based on their position, velocity, and acceleration, may collide with the vehicle as it travels forward along the route.

In response to a detected obstacle, the vehicle can stop 804, for example. In some examples, one or more indicator systems of the vehicle can alert a vehicle user that the vehicle has stopped in response to a detected obstacle. For example, the vehicle can play a sound, provide tactile feedback, and/or display an alert (e.g., at an infotainment panel, a mobile device, or other display).

Optionally, in some examples, the vehicle can recalculate 806 a path in response to the obstacle. Recalculation can occur automatically in response to waiting a predetermined amount of time for the obstacle to move or in response to a user input, for example. In some examples, the vehicle can automatically generate an alternative path. For example, the vehicle can select a path with minimal deviation from the pre-determined path. Additionally or alternatively, the user can provide an input (e.g., a path, an endpoint, a vehicle pose, and/or a series of waypoints) to determine the new path.

In some examples, the vehicle can monitor its surroundings to determine 808 if the path is clear. Determining 808 if the path is clear can include determining if the obstacle has moved away from the pre-determined path, for example. In some examples, determining 808 if the path is clear can include determining if the newly generated path is clear.

In accordance with a determination that the vehicle's path is clear, in some examples, the vehicle can drive 810 autonomously once again. While driving autonomously, the vehicle can continue to monitor its surroundings to avoid a collision.

In accordance with a determination that the vehicle's path is not clear, in some examples, the vehicle can remain stopped 804 to wait for its path to clear. In some examples, the vehicle can generate a notification (e.g., an auditory notification, a visual notification, etc.) to terminate autonomous driving to allow a human driver, such as the user, to take over. Alternatively, in some examples, the process 800 can continue to monitor the vehicle's surroundings to determine when it is safe to drive 810 autonomously. In some examples, a new path can be generated 806.

It should be appreciated that in some embodiments a learning algorithm can be implemented such as an as a neural network (deep or shallow, which may employ a residual learning framework) and be applied instead of, or in conjunction with another algorithm described herein to solve a problem, reduce error, and increase computational efficiency. Such learning algorithms may implement a feedforward neural network (e.g., a convolutional neural network) and/or a recurrent neural network, with supervised learning, unsupervised learning, and/or reinforcement learning. In some embodiments, backpropagation may be implemented (e.g., by implementing a supervised long short-term memory recurrent neural network, or a max-pooling convolutional neural network which may run on a graphics processing unit). Moreover, in some embodiments, unsupervised learning methods may be used to improve supervised learning methods. Moreover still, in some embodiments, resources such as energy and time may be saved by including spiking neurons in a neural network (e.g., neurons in a neural network that do not fire at each propagation cycle).

In some examples, sensor data can be fused together (e.g., LiDAR data, radar data, ultrasonic data, camera data, etc.). This fusion can occur at one or more electronic control units (ECUs). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance.

Therefore, according to the above, some examples of the disclosure are directed to a method of determining a path of travel for a vehicle, the method comprising: generating a three-dimensional (3D) model of the vehicle's surroundings; converting the 3D model to a two-dimensional (2D) occupancy grid map; receiving a user input indicative of one or more points along a desired path; determining a finalized path in accordance with the user input; and autonomously driving along the finalized path. Additionally or alternatively to one or more of the examples disclosed above, the 3D model is generated based on data from one or more sensors included in the vehicle. Additionally or alternatively to one or more of the examples disclosed above, the occupancy grid map includes a footprint of one or more objects included in the 3D model. Additionally or alternatively to one or more of the examples disclosed above, the user input includes one or more of a user-defined path, an endpoint, a vehicle pose, and a series of waypoints. Additionally or alternatively to one or more of the examples disclosed above, the user input is received at a computing device operatively coupled to the vehicle. Additionally or alternatively to one or more of the examples disclosed above, the method further comprises generating an optimal path based on the user input. Additionally or alternatively to one or more of the examples disclosed above, the method further comprises generating a smooth path based on the user input. Additionally or alternatively to one or more of the examples disclosed above, the finalized path is at least a pre-defined minimum distance away from any obstacles included in the occupancy grid map at all points. Additionally or alternatively to one or more of the examples disclosed above, the method further comprises, while driving autonomously: in accordance with a determination that there is an obstacle along the finalized path, stopping the vehicle. Additionally or alternatively to one or more of the examples disclosed above, the method further comprises: in accordance with the determination that there is an obstacle along the finalized path, determining a new path and driving along the new path. Additionally or alternatively to one or more of the examples disclosed above, the method further comprises: in accordance with a determination that there is no longer an obstacle along the finalized path, resuming driving along the finalized path.

According to the above, some examples of the disclosure are direct to a vehicle comprising a processor, the processor configured for: generating a three-dimensional (3D) model of the vehicle's surroundings; converting the 3D model to a two-dimensional (2D) occupancy grid map; receiving a user input indicative of one or more points along a desired path; determining a finalized path in accordance with the user input; and autonomously driving along the finalized path.

According to the above, some examples of the disclosure are directed to a non-transitory computer-readable storage medium storing instructions that, when executed by one or more processors of a vehicle, causes the processor to perform a method of determining a path of travel for the vehicle, the method comprising: generating a three-dimensional (3D) model of the vehicle's surroundings; converting the 3D model to a two-dimensional (2D) occupancy grid map; receiving a user input indicative of one or more points along a desired path; determining a finalized path in accordance with the user input; and autonomously driving along the finalized path.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method of determining a path of travel for a vehicle, the method comprising:
generating a three-dimensional (3D) model of the vehicle's surroundings;
converting the 3D model to a two-dimensional (2D) occupancy grid map;
receiving a user input indicative of one or more points along a desired path;
determining a finalized path in accordance with the user input; and
autonomously driving along the finalized path.

2. The method of claim 1, wherein the 3D model is generated based on data from one or more sensors included in the vehicle.

3. The method of claim 1, wherein the occupancy grid map includes a footprint of one or more objects included in the 3D model.

4. The method of claim 1, wherein the user input includes one or more of a user-defined path, an endpoint, a vehicle pose, and a series of waypoints.

5. The method of claim 1, wherein the user input is received at a computing device operatively coupled to the vehicle.

6. The method of claim 1, further comprising generating an optimal path based on the user input.

7. The method of claim 1, further comprising generating a smooth path based on the user input.

8. The method of claim 1, wherein the finalized path is at least a pre-defined minimum distance away from any obstacles included in the occupancy grid map at all points.

9. The method of claim 1, further comprising, while driving autonomously:
in accordance with a determination that there is an obstacle along the finalized path, stopping the vehicle.

10. The method of claim 9, further comprising:
in accordance with the determination that there is an obstacle along the finalized path, determining a new path and driving along the new path.

11. The method of claim 9, further comprising:
in accordance with a determination that there is no longer an obstacle along the finalized path, resuming driving along the finalized path.

12. A vehicle comprising a processor, the processor configured for:
generating a three-dimensional (3D) model of the vehicle's surroundings;
converting the 3D model to a two-dimensional (2D) occupancy grid map;
receiving a user input indicative of one or more points along a desired path;
determining a finalized path in accordance with the user input; and
autonomously driving along the finalized path.

13. A non-transitory computer-readable storage medium storing instructions that, when executed by one or more processors of a vehicle, causes the processor to perform a method of determining a path of travel for the vehicle, the method comprising:
generating a three-dimensional (3D) model of the vehicle's surroundings;
converting the 3D model to a two-dimensional (2D) occupancy grid map;
receiving a user input indicative of one or more points along a desired path;
determining a finalized path in accordance with the user input; and
autonomously driving along the finalized path.
